(19) United States
(12) Patent Application Publication
(10) Pub. No.: US 2015/0318674 A1
(43) Pub. Date: Nov. 5, 2015

(54) Wire Puller

(71) Applicants: David Peavy, Texarkana, AR (US); Michael Luckenbaugh, Texarkana, AR (US)

(72) Inventors: David Peavy, Texarkana, AR (US); Michael Luckenbaugh, Texarkana, AR (US)

(21) Appl. No.: 14/267,459

(22) Filed: May 1, 2014

(51) Int. Cl. H02G 1/08; B62B 1/02; F16L 3/12

(52) U.S. Cl. CPC H02G 1/081; F16L 3/1222; F16L 3/1218; B62B 1/02

(57) ABSTRACT

A system and method for a cart puller. The cart has a puller portion which is coupled to the cart portion. The puller portion has at least one arm coupled to a motor, which is further coupled to a wrapper. The cart portion has at least one wheel, and the arm has a puller head which is coupled to a mount. The mount is couples to a pipe through which wire is to be retrieved. The motor rotates the wrapper such that wire is retrieved from the pipe by the wrapper.

### BACKGROUND OF THE INVENTION

1. Technical Field

The present invention relates to a system and method for pulling wire with a cart puller.

2. Description of Related Art

A wire puller is used to pull wire. However, it is difficult to maneuver and utilize these devices. Further, these devices do not adequately and securely attach to the pipe from which the wire is being withdrawn. Consequently, there is a need for a wire puller which can be maneuvered and which securely attaches to the pipe.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a cart puller in one embodiment;

FIG. 2 is a perspective view of a cart puller in an extended position in one embodiment;

FIG. 3 is a perspective view of the stabilizer mount being aligned in one embodiment;

FIG. 4 is a perspective view of the stabilizer mount mounted on a pipe in one embodiment;

FIG. 5 is a perspective view of an adapter in one embodiment;

FIG. 6 is a perspective view of a cart puller in one embodiment;

FIG. 7 is a perspective view of a cart puller in an extended position in one embodiment;

FIG. 8 is a perspective view of the base arm extending from the cart base in one embodiment;

FIG. 9 is a perspective view of the puller head aligning with the stabilizer mount in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

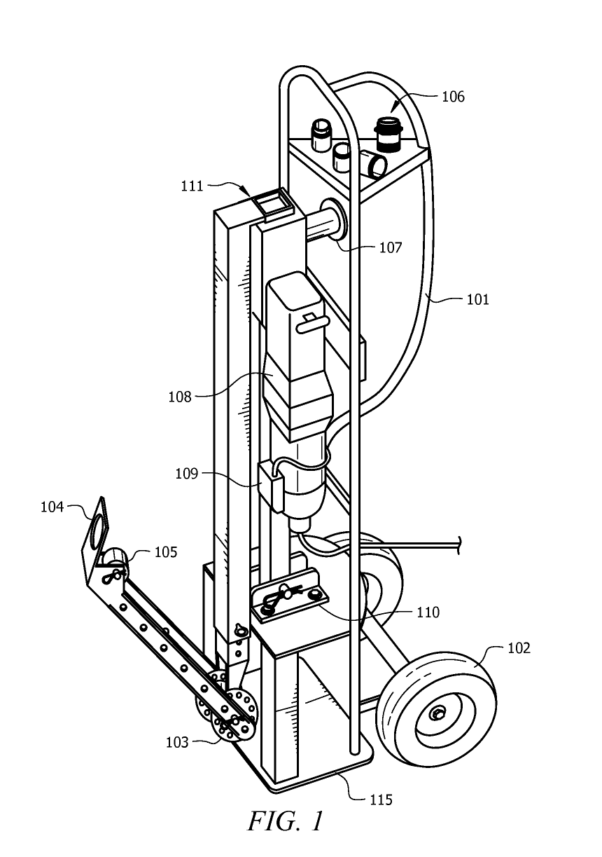

FIG. 1 is a perspective view of a cart puller in one embodiment. As used herein, a cart puller refers to a wire puller which is coupled to a cart. A cart refers to a mobile device which is used for moving and transporting equipment. A cart includes, but is not limited to, a dolly, a furniture dolly, a piano dolly, a wagon, a traditional cart, etc. A wire puller is a device which is coupled to wire such that the wire can be retrieved, such as, for example, through an electrical panel. Virtually any type of wire puller can be utilized. In one embodiment, a wire puller similar to the StrongArm™ manufactured by RectorSeal of Houston, Tex., is utilized.

As seen in FIG. 1, the wire puller is mounted to a cart, which as illustrated, is a dolly. This is for illustrative purposes only and should not be deemed limiting. The cart comprises a frame 101 which provides the cart structure and a base 115. The frame 101 can comprise virtually any material which provides the required rigidity and structure, including but not limited to, steel, iron, polymers, suitable plastics or rubbers, brass, aluminum, and other metals. As depicted, the cart is resting upon the cart base 115. The cart base 115 is adjacent to wheels 102. As depicted the cart has two wheels 102, but in other embodiments the cart comprises one, or more than two wheels 102.

The cart puller, as depicted, also comprises a motor 108. The motor 108 can be used to initiate the wire pulling or continue the wire pulling. The wire is typically in a conduit or other pipe. If the wire is old, exposed, or is in condition to be replaced, the wire is pulled from the pipe with a wire puller. The motor 108 can comprise a reversible motor, a multi-speed motor, and virtually any type of motor which rotates a wrapper 107.

In one embodiment the motor 108 is coupled to a rotatable wrapper 107. The wrapper 107 is a cylindrical device which is secured and coupled to the cart puller. The motor 108 causes the wrapper 107 to rotate. A rope, chain, wire or other coupling device is first attached to the wire to be pulled. An embodiment will be described using a rope, but this is for illustrative purposes only and should not be deemed limiting. The rope is then wrapped around the wrapper 107. When the motor 108 causes the wrapper 107 to rotate, the rope is pulled and wraps around the wrapper 107. As the rope is being pulled, wire is pulled behind it. Simultaneously with pulling new rope, the operator unravels rope that has already been pulled from the wrapper 107. In this manner, the rope is simultaneously secured, pulled, and collected by the rotating wrapper 107. In one embodiment the operator maintains three wraps of rope on the wrapper 107. Once the rope has been pulled, the wire connected to the rope is pulled from the pipe. In one embodiment 4-5 feet of wire is pulled from the pipe to allow sufficient room to connect the wire.

Coupled to the motor 108 is an optional motor control 109. The motor control 109 comprises a switch or other device to activate and/or control the motor 108. In one embodiment the motor control 109 comprises a foot switch which can be controlled by a user's foot. This allows the operator's hands to remain free to wrap and organize the pulled wire or rope. The operator, with their foot, can control the motor's 108 operation, including whether the motor is operating, and in some embodiments, the speed and/or direction or rotation of the motor 108.

The cart puller 100 of FIG. 1 is in an upright and semi-compact orientation. The puller portion which comprises the motor 108, the wrapper 107, the arm, and any necessary structure, is coupled to the cart portion. As used herein, coupling refers to direct and indirect coupling. As depicted, the puller portion is coupled to the cart at the puller base 110. In one embodiment the puller portion is coupled to the cart only at the puller base 110. By coupling at a single point, the flexibility of the puller portion is increased.

The puller base 110, as depicted, is bolted to the cart at a location which is elevated relative to the cart base 115. The reason for this is that the elevation provides sufficient storage space and length for the puller arm.

The puller base 110, as depicted, comprises a hinge point which allows the puller portion to rotate about the pin. Thus, while FIG. 1 illustrates the puller portion being approximately vertical in the compact position, the puller portion can be rotated to comprise virtually any angle.

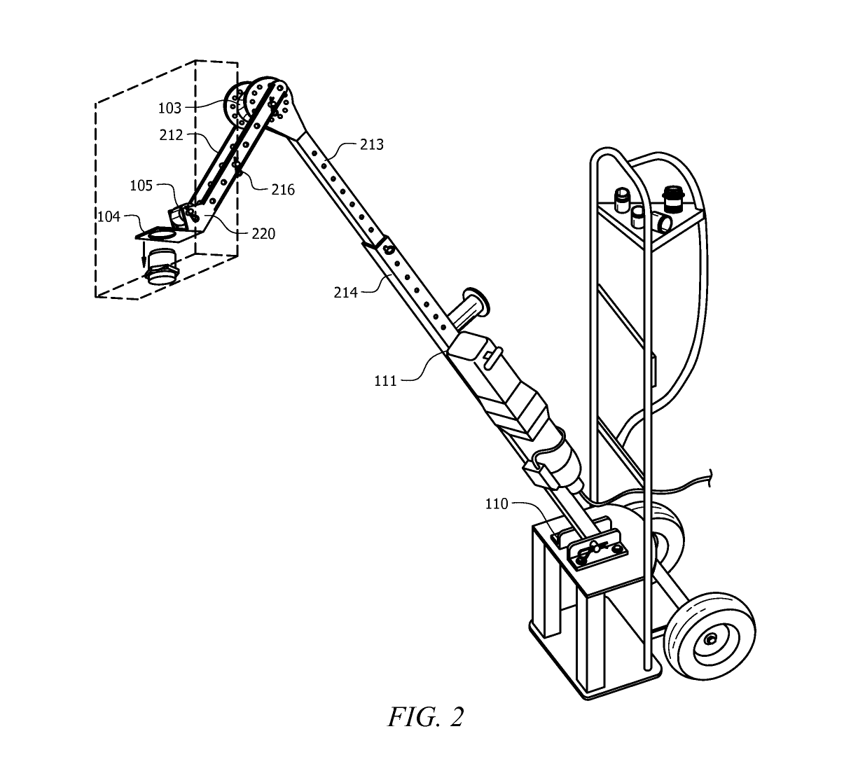

FIG. 2 is a perspective view of a cart puller in an extended position in one embodiment. In an extended position the arm extends outward from the cart. As can be seen, the base arm 214 is coupled to, and extends away from the body of the puller portion. The base arm 214, as depicted, is coupled at a connector 111. The connector 111 can comprise any device known to connect and couple two items. In one embodiment the connector 111 comprises a pin which secures the base arm 214 to body of the puller portion. The connector 111 can also comprise a pivot point allowing the arm pivot and rotate relative to the puller portion. The pivot point can comprise any joint or hinge which allows the arm to rotate.

The base arm 214 can be made from virtually any material including stainless steel, other metals, polymers, brass, aluminum, any material listed above, etc. The length of the base arm 214 can vary depending on the type of wire to be pulled. In one embodiment the base arm 214 has a length of between about 2 feet and about 4 feet. In one embodiment the base arm 214 has a length of about 3 feet.

In one embodiment, the base arm 214 is further coupled to an intermediate arm 213. The base arm 214 and the intermediate arm 213 can be coupled with any device or method known in the art. In one embodiment, the intermediate arm 213 comprises a smaller effective diameter such that it fits within the base arm 214. This allows for a more compact storage but simultaneously provides the operator the ability to extend the arm to a desired length. In one embodiment, both the intermediate arm 213 and the base arm 214 comprise holes. A pin is inserted between the holes to secure the intermediate arm 213 at the desired length along the base arm 214. In one embodiment the intermediate arm 213 has a length of between about 2 feet and about 4 feet. In one embodiment the intermediate arm 213 has a length of about 3 feet. In one embodiment the intermediate arm 213 has a length similar to the length of the base arm 214.

As depicted, the intermediate arm 213 is coupled at one end to a rotary hinge 103 which is further coupled to the mounting arm 212. In one embodiment the rotary hinge 103 is permanently coupled to the intermediate arm 213 whereas in other embodiments the rotary hinge 103 is permanently coupled to the mounting arm 212. While the mounting arm 212 and intermediate arm 213 are shown as being coupled via a rotary hinge 103, this is for illustrative purposes and should not be deemed limiting. The rotary hinge 103, or other suitable joint, allows the angle between the mounting arm 212 and the intermediate arm 213 to be adjusted. The mounting arm 212, as depicted, comprises holes located along its length. The pin 216 slides through the holes in the mounting arm 212 and the holes of the rotary hinge 103. The angle, and in one embodiment the length, of the mounting arm 212 can be adjusted by placing the holes through different holes in the rotary hinge 103 and/or the mounting arm 212. In one embodiment the mounting arm 213 has a length of between about 1 foot and about 2 feet. In one embodiment the mounting arm 213 has a length of about 18 inches.

As depicted, a first end of the mounting arm 212 is coupled to a rotary hinge 103. The second end of the mounting art 212 is coupled to a puller head 220. The puller head 220 is the downstream end of the arm. As used herein, the term downstream refers to a position removed from the cart puller. Thus, as depicted in FIG. 2 the puller head 220 is downstream of the rotary hinge 103, and the rotary hinge 103 is upstream of the puller head 220. The puller head 220 also comprises a roller 105. The rope and wire rest and roll upon the roller 105. The roller 105 reduces friction as the rope and wire are pulled. In one embodiment the rotary hinge 103 also comprises a roller or other device to reduce friction and redirect force. The ability to redirect force allows the motor 108 to be stored in a suitable location during pulling. Without redirecting force, via a roller, hinge, etc., if a wire is to be pulled up from the ground, the motor 108 would necessarily have to be located above the wire to provide an upward force. However, as depicted in FIG. 2, the motor 108 is able to provide a downward force, which is redirected as an upward force by the rotary hinge 103. As noted, this provides the ability to position the motor 108 is a more suitable, and safe, location.

As can be seen, the length and angle of the arm of the cart puller can be adjusted. In one embodiment the arm has two or more hinges. Thus, this ability to adjust length and angle allows the stabilizer mount 104 to be adjusted to properly align on the pipe, conduit, or other structure.

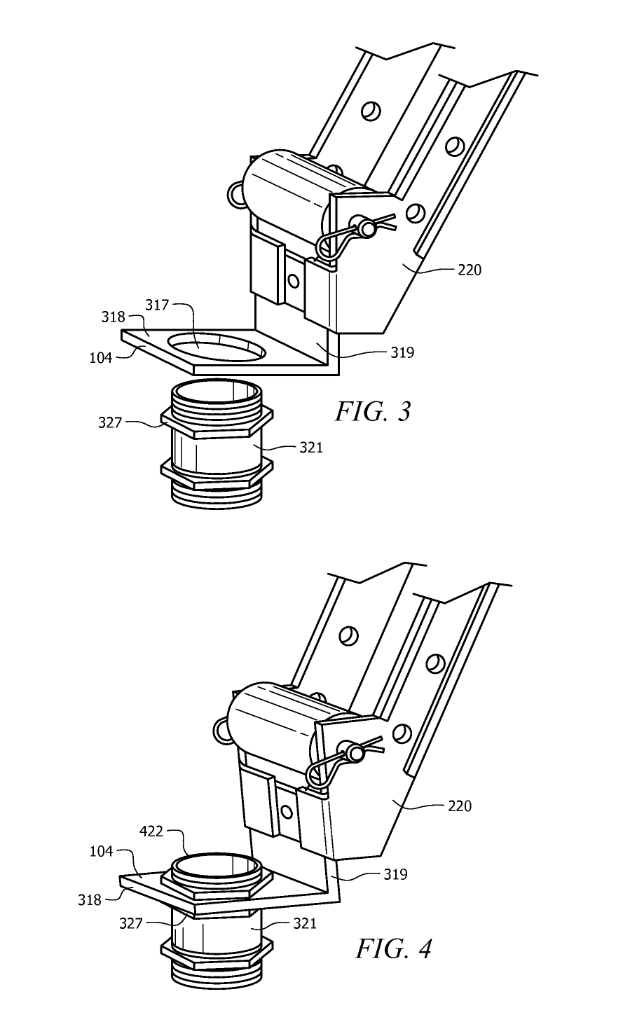

FIG. 3 is a perspective view of the mount being aligned in one embodiment. As seen, the stabilizer mount 104 is positioned so as to fit securely around the pipe 321. As previously noted, the pipe 321 can comprise a pipe, a conduit, or virtually any structure which houses wire. An embodiment utilizing a pipe 321 will be discussed, but this is for illustrative purposes only and should not be deemed limiting. Often access to the pipe 321 is obtained in an electrical panel.

In one embodiment the mount 104 comprises a void 317 through which the pipe 321 is inserted. The size of the void 317 can be adjusted depending on the size of the pipe 321, size of the wire, etc. In one embodiment the void 317 is sized to fit a 2 inch diameter pipe. In one embodiment the void 317 comprises a diameter of about 2 and ¾ inches to fit around a 2 inch diameter pipe. In one embodiment, the void 317 is completely enclosed and surrounded by the mount 104. Virtually any diameter pipe, from 0.5 inches to 6 inches or more, can be utilized.

In one embodiment the pipe 321 comprises a pipe lip 327. In one embodiment the void 317 has a diameter greater than the diameter of the pipe 321 but less than the diameter of the pipe lip 327. In such embodiments, the stabilizer mount 104, when properly aligned, will rest upon the pipe lip 327.

The stabilizer mount 104 can comprise virtually any material. It can comprise stainless steel, steel, polymers, rubber, cast iron, brass, aluminum, and other strong metals or materials such as strong polymers.

As depicted the stabilizer mount 104 comprises a horizontal plate 318 and a vertical plate 319. In one embodiment, the vertical plate 319 is approximately perpendicular to the horizontal plate 318. Such an orientation provides a transition from the puller head 220 and the stabilizer mount 104. Further, such an orientation provides for increased strength. As depicted the void 317 is located on the horizontal plate 318. The thickness of the horizontal plate 318 can vary depending upon the size of the pipe 321 but in one embodiment ranges from about ⅛ of an inch to about ½ of an inch. In one embodiment the horizontal plate 318 has a thickness of about ¼ of an inch. As stated above, however, this can be increased or decreased depending upon the size of the pipe 321. For example, for a pipe with a 6″ diameter, the thickness can increase to ¾ of an inch.

The vertical plate 319, as depicted, couples to the puller head 220. The puller head 220 can be coupled to the mount 104 via any method or device known in the art including bolts, nuts, screws, mating slots, or other mechanical coupling.

FIG. 4 is a perspective view of the stabilizer mount 104 mounted on a pipe 321 in one embodiment. As shown, the pipe 321 extends through the void 317 of the mount and is fully enclosed by the horizontal plate 318 of the mount. Because the stabilizer mount 104 fully surrounds the pipe 321, the coupling between the mount 104 and the pipe 321 is more secure. Further, because a solid sheet of material in the stabilizer mount 104 surrounds the pipe 321, the solid sheet of material would have to break before the arm becomes decoupled from the pipe 321. Such a stabilizer mount 104 offers superior support and strength compared to embodiments if the mount was coupled via a wire or chain, which are easily breakable; a solid mount which completely surrounds the pipe, such as depicted in FIG. 4, is stronger and more secure than a wire or chain.

As noted, wire is pulled by a wrapper 107 which is turned by a motor 108. The wire and cart puller are under tremendous tension. Because the cart puller is coupled to the pipe 321 via the stabilizer mount 104, the tension is focused on the mount 104. Thus, having a strong mount, such as the mount depicted in FIG. 4, which can withstand the tension, is a tremendous advantage. The stabilizer mount 104 keeps the distance between the pipe 321 and the wrapper 107 constant. If the stabilizer mount 104 were to break, there is nothing to keep the wrapper 107 and the cart puller 100 from being urged toward the pipe 321 under the weight and tension of the wire. Such a result poses a safety concern as a large piece of equipment, which is coupled to wire, is urged forward toward or on an operator. Further, if the stabilizer mount 104 were to break, this results in significant downtime as the cart puller 100 would need to be adjusted and reset, and the stabilizer mount 104 would need to be replaced, before the wire pulling could start again. Wires or chains are susceptible to frequent breaking and are therefore not satisfactory mounts. Further, wires or chains are susceptible to loose connections, causing the chains to flopping and losing connection. This causes the operator downtime to readjust and reconnect, and often causes damage to the wire. If a portion of wire is damaged, the entire length of wire must be pulled. Often, such mistakes result in tens of thousands dollars of wires which must be replaced. The stabilizer mount 104 comprising a void 317 which is fully enclosed, offering increased strength and rigidity. This increases effectiveness of the cart puller 100, the safety of the cart puller 100, and decreases downtime.

As depicted in FIG. 4, the pipe 321 comprises threading 422 which extends above the mount 104 when properly aligned. A nut or other cap can be threaded upon the threading 422, such as depicted. This nut further locks the mount 104 onto the pipe 321 and prevents decoupling. In one embodiment wherein the pipe comprises a pipe lip 327, as discussed above and depicted in FIG. 4, the nut locks the mount 104 between the nut and the pipe lip 327.

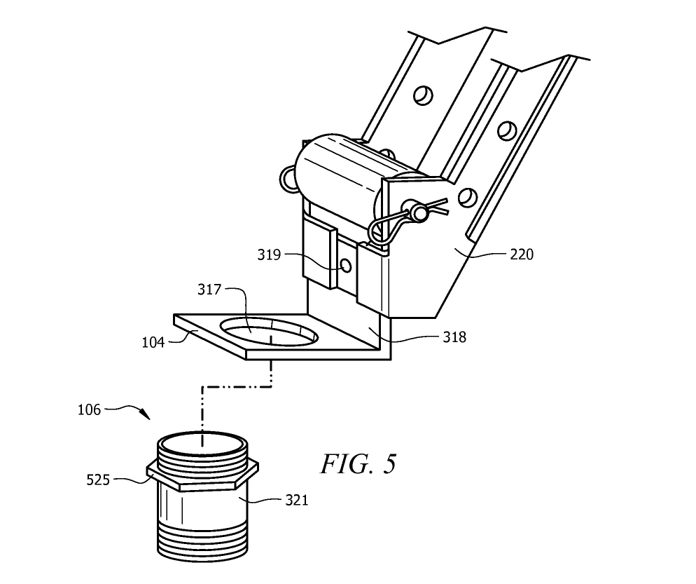

FIG. 5 is a perspective view of an adapter in one embodiment. An adapter 106 is used to allow a single mount 104 to be used on pipes 321 of different sizes. Thus, rather than have to carry one mount 104 for a two inch pipe and a second mount 104 for a 1.5 inch pipe, a single stabilizer mount 104 can be used with adapters 106. An adapter 106 can comprise any method known for reducing or enlarging diameter of a pipe. As depicted the adapter 106 comprises an enlarged diameter portion 525. When the adapter 106 is coupled to the pipe 321, then the mount 104 can utilize the larger diameter of the enlarged diameter portion 525. In one embodiment the adapter 106 is threaded to receive the reduced diameter of the pipe 321 but comprises the enlarged diameter portion 525 to allow the stabilizer mount 104 to be utilized. As an illustrative example, if the pipe 321 is 1.5 inch in diameter, it will screw into the female portion of the adapter 106 which is sized to receive a 1.5 inch pipe. However, because the adapter 106 also comprises an enlarged diameter portion 525 with a diameter of 2 inches, this enlarged diameter portion 525 can be used with a mount 104 sized for a two inch pipe. Those skilled in the art will understand how to create adapters which reduce or enlarge a diameter of a pipe.

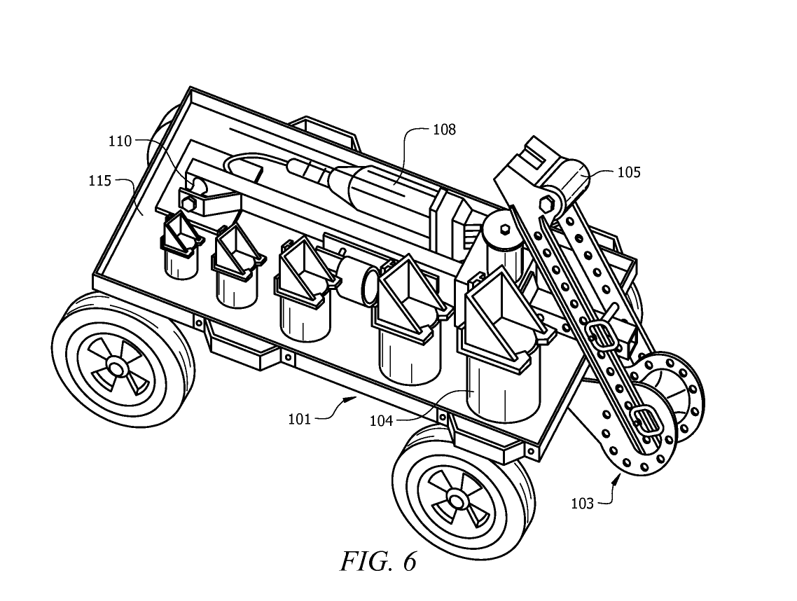

FIG. 6 is a perspective view of a cart puller in one embodiment. As depicted, the cart puller 100 is a wagon which comprises four wheels. The cart puller 100 comprises a handle to pull and maneuver the cart puller. In one embodiment the cart puller has at least one wheel which can be turned to allow steering. As depicted, the cart base 115 is in a plane which is approximately parallel to the floor. Several stabilizer mounts 104 of different sizes rest upon the cart base 115. A similar puller portion as shown in FIG. 1 is utilized in FIG. 6. Thus, FIG. 6 shows a rotary hinge 103, a roller 105, an arm, and a motor 108.

As depicted, the base arm 214 is stored below the cart base 115. This results in a more compact cart puller 100. In one embodiment a pipe is fastened to the bottom of the cart base 115 which provides for storage of the base arm 214. In other embodiments, however, the arm is stored above the cart base 115.

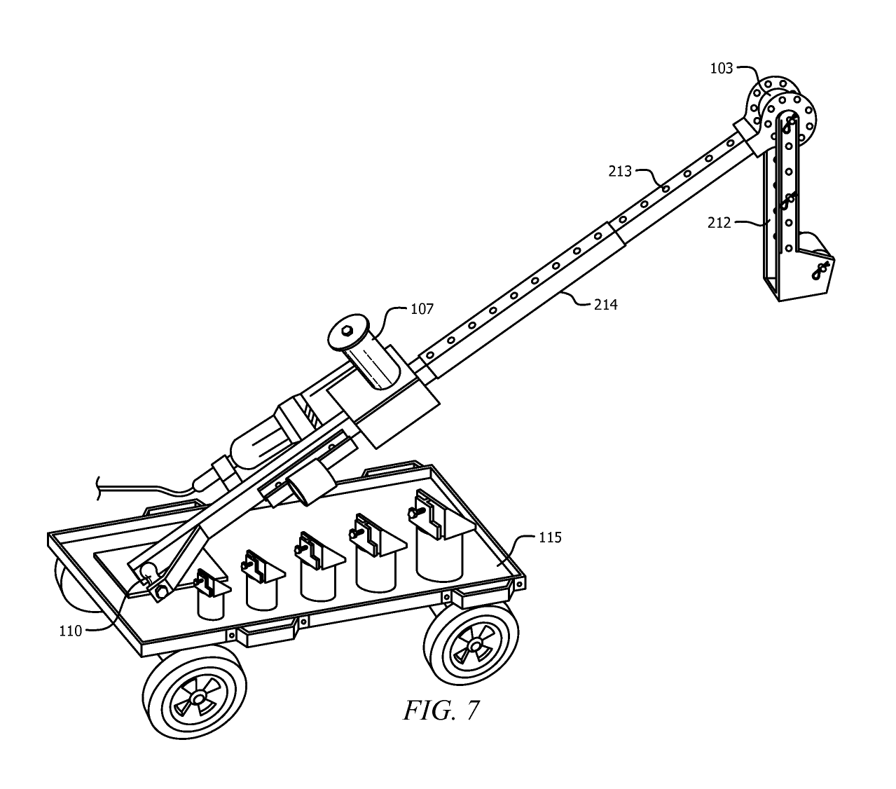

FIG. 7 is a perspective view of a cart puller in an extended position in one embodiment. As can be seen the puller portion attaches to the cart base 115 via the puller base 110. As shown, the puller base 110 has a hinge such that the arm can rotate relative to the cart base 115. In one embodiment, the puller portion attaches to the cart only at the cart base 110. As previously noted, this is an advantage in some embodiments because it results in increased maneuverability of the puller portion.

The base arm 214 is coupled to the puller portion. In one embodiment the base arm 214 is coupled via a pin which is inserted through holes located on the puller portion. The base arm 214 is further coupled to the intermediate arm 213. The intermediate arm 213 is coupled to a rotary hinge 103, which is coupled to the mount arm 212. As depicted, the mount arm 212 comprises a roller to aid with the rope and wire.

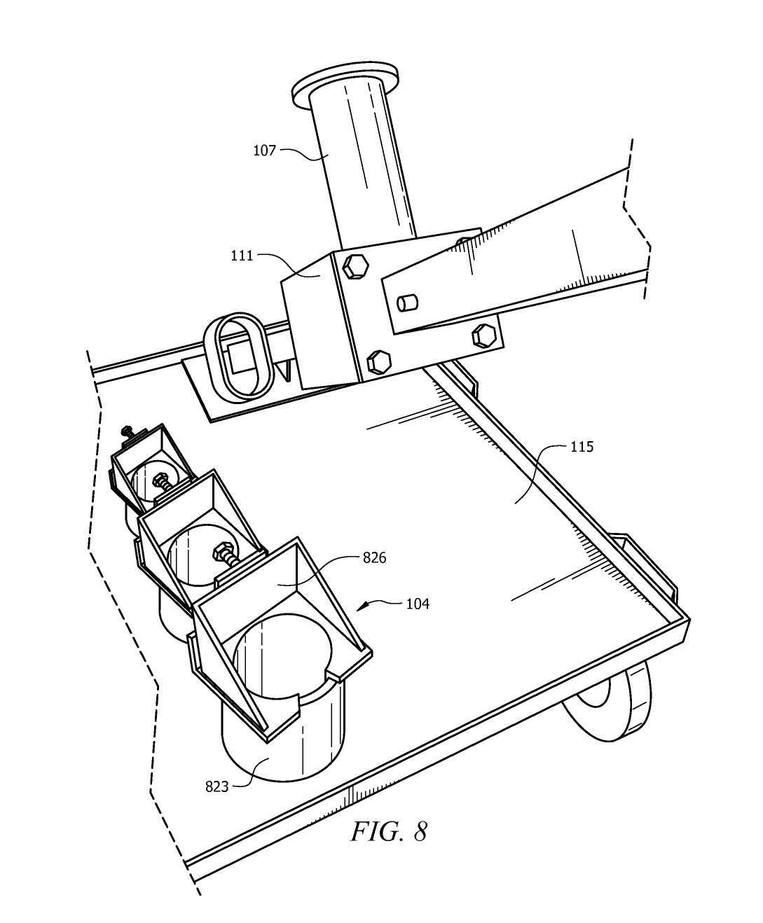

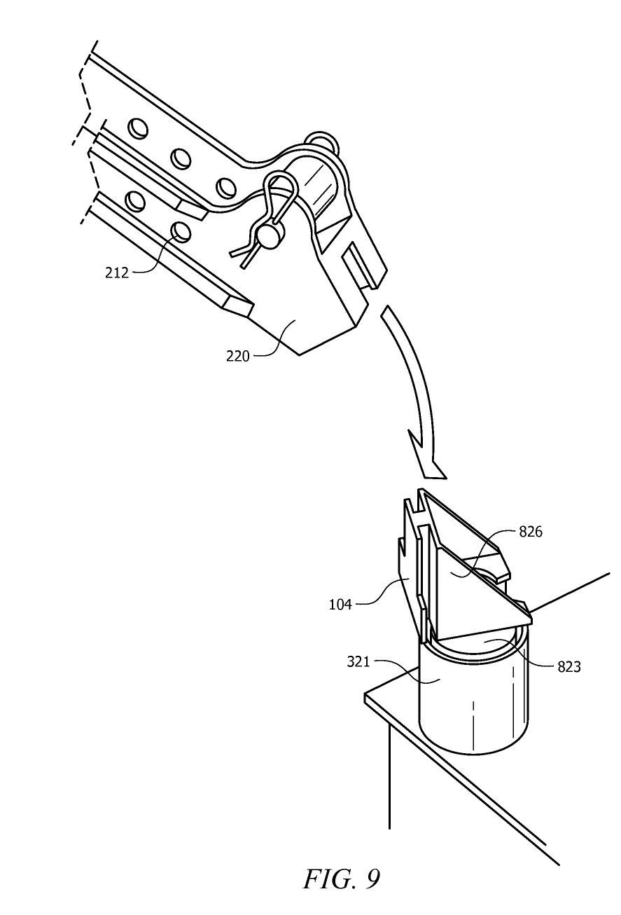

FIG. 8 is a perspective view of the base arm extending from the cart base in one embodiment. FIG. 8 depicts a stabilizer mount 104 which is different than the mount shown in FIGS. 1-6. As depicted the mounts 104 in FIG. 8 comprise a fitting portion 823 and a coupling portion 826. The fitting portion 823, as depicted, comprises a cylindrical pipe, though it can comprise virtually any shape. The fitting portion 823 fits within or around the pipe 321 from which wire is to be withdrawn. Thus, when tension is applied to the top of the mount 104, the bottom of the fitting portion 823 is forced about the inside of the pipe 321, keeping the stabilizer mount 104 secure. Note that the fitting portion 823 is not clearly visible in FIG. 9 because it is hidden within the mount holder which acts as a pipe.

The coupling portion 826 is the portion which couples with the puller head 220 (not pictured in FIG. 8) of the puller portion. As with the stabilizer mount 104 previously discussed, the coupling portion 826 can be coupled with any device or method known in the art. An example of one type of mount 104 is depicted in FIG. 9, which is a perspective view of the puller head aligning with the mount in one embodiment. As depicted, the coupling portion 826 comprises a male slot which fits within a female recess located on the puller head 220. Once fitted the two pieces can be secured with a bolt, screw, or other such device. As seen in FIG. 9, the fitting portion 823 of the stabilizer mount 104 is inserted into the pipe 321.

While the invention has been particularly shown and described with reference to a preferred embodiment, it will be understood by those skilled in the art that various changes in form and detail may be made therein without departing from the spirit and scope of the invention.

### Additional Description

The following clauses are offered as further description of the disclosed invention.

Clause 1. A cart puller comprising:
a puller portion coupled to a cart portion;
wherein the puller portion comprises at least one arm coupled to a motor, wherein the motor is coupled to a wrapper;
wherein the cart portion comprises at least one wheel;
wherein the at least one arm comprises a puller head which is coupled to a stabilizer mount.

Clause 2. The cart puller of any preceding or any proceeding claim wherein said at least one arm comprises three arms, a base arm coupled to an intermediate arm, and a mounting arm coupled to an intermediate arm, wherein the mounting arm is coupled to said puller head.

Clause 3. The cart puller of any preceding or any proceeding claim wherein said intermediate arm and said mounting arm are coupled via a rotary hinge.

Clause 4. The cart puller of any preceding or any proceeding claim wherein the length of said intermediate arm is adjustable.

Clause 5. The cart puller of any preceding or any proceeding claim wherein said cart portion comprises a dolly, wherein said dolly comprises two wheels.

Clause 6. The cart puller of any preceding or any proceeding claim wherein said cart portion comprises a wagon, and wherein the wagon comprises more than 2 wheels.

Clause 7. The cart puller of any preceding or any proceeding claim wherein said stabilizer mount comprises a horizontal plate and a vertical plate, wherein the horizontal plate comprises a void, and wherein said vertical plate couples to said puller head.

Clause 8. The cart puller of any preceding or any proceeding claim wherein said void is completely enclosed and surrounded by the mount.

Clause 9. The cart puller of any preceding or any proceeding claim wherein said stabilizer mount comprises a fitting portion and a coupling portion, wherein the coupling portion couples to said puller head, and wherein said fitting portion fits within a pipe.

Clause 10. A system for pulling wire, said system comprising:
a puller portion comprising at least one arm coupled to a motor, and a wrapper coupled to the motor;
a cart portion comprising at least one wheel, wherein the cart portion is coupled to the puller portion;
wherein the at least one arm comprises a puller head which is coupled to a stabilizer mount;
wherein the stabilizer mount couples to a pipe, and wherein the pipe comprises wire to be retrieved,
wherein the motor rotates the wrapper such that wire is retrieved from the pipe by the wrapper.

Clause 11. The system of any preceding or any proceeding claim wherein said stabilizer mount comprises a fitting portion and a coupling portion, wherein the coupling portion couples to said puller head, and wherein said fitting portion fits within said pipe.

Clause 12. The system of any preceding or any proceeding claim wherein said mount comprises a horizontal plate and a vertical plate, wherein the horizontal plate comprises a void, and wherein said vertical plate couples to said puller head.

Clause 13. The system of any preceding or any proceeding claim wherein said void is completely enclosed and surrounded by the stabilizer mount.

Clause 14. The system of any preceding or any proceeding claim wherein said cart portion comprises a dolly, wherein said dolly comprises two wheels.

Clause 15. The cart puller of any preceding or any proceeding claim wherein said cart portion comprises a wagon, and wherein the wagon comprises more than 2 wheels.

Clause 16. A mount for coupling to a wire puller, said mount:
comprises a horizontal plate coupled to a vertical plate;
wherein the horizontal plate comprises a void for receiving a pipe; and
wherein said vertical plate can couple to a puller head on said wire puller.

Clause 17. The mount of any preceding or any proceeding claim wherein said void is completely enclosed and surrounded by the mount.

Clause 18. The mount of any preceding or any proceeding claim wherein said horizontal plate is approximately perpendicular to said vertical plate.

Clause 19. The mount of any preceding or any proceeding claim wherein said vertical plate comprises a hole for coupling onto a puller head.

What is claimed is:

1. A cart puller comprising:
a puller portion coupled to a cart portion;
wherein the puller portion comprises at least one arm coupled to a motor, wherein the motor is coupled to a wrapper;
wherein the cart portion comprises at least one wheel;
wherein the at least one arm comprises a puller head which is coupled to a stabilizer mount.

2. The cart puller of claim 1 wherein said at least one arm comprises three arms, a base arm coupled to an intermediate arm, and a mounting arm coupled to an intermediate arm, wherein the mounting arm is coupled to said puller head.

3. The cart puller of claim 2 wherein said intermediate arm and said mounting arm are coupled via a rotary hinge.

4. The cart puller of claim 2 wherein the length of said intermediate arm is adjustable.

5. The cart puller of claim 1 wherein said cart portion comprises a dolly, wherein said dolly comprises two wheels.

6. The cart puller of claim 1 wherein said cart portion comprises a wagon, and wherein the wagon comprises more than 2 wheels.

7. The cart puller of claim 1 wherein said stabilizer mount comprises a horizontal plate and a vertical plate, wherein the horizontal plate comprises a void, and wherein said vertical plate couples to said puller head.

8. The cart puller of claim 7 wherein said void is completely enclosed and surrounded by the mount.

9. The cart puller of claim 1 wherein said stabilizer mount comprises a fitting portion and a coupling portion, wherein the coupling portion couples to said puller head, and wherein said fitting portion fits within a pipe.

10. A system for pulling wire, said system comprising:
a puller portion comprising at least one arm coupled to a motor, and a wrapper coupled to the motor;
a cart portion comprising at least one wheel, wherein the cart portion is coupled to the puller portion;
wherein the at least one arm comprises a puller head which is coupled to a stabilizer mount;
wherein the mount couples to a pipe, and wherein the pipe comprises wire to be retrieved,
wherein the motor rotates the wrapper such that wire is retrieved from the pipe by the wrapper.

11. The system of claim 10 wherein said stabilizer mount comprises a fitting portion and a coupling portion, wherein the coupling portion couples to said puller head, and wherein said fitting portion fits within said pipe.

12. The system of claim 10 wherein said stabilizer mount comprises a horizontal plate and a vertical plate, wherein the horizontal plate comprises a void, and wherein said vertical plate couples to said puller head.

13. The system of claim 10 wherein said void is completely enclosed and surrounded by the stabilizer mount.

14. The system of claim 10 wherein said cart portion comprises a dolly, wherein said dolly comprises two wheels.

15. The cart puller of claim 10 wherein said cart portion comprises a wagon, and wherein the wagon comprises more than 2 wheels.

16. A mount for coupling to a wire puller, said mount:
comprises a horizontal plate coupled to a vertical plate;
wherein the horizontal plate comprises a void for receiving a pipe; and
wherein said vertical plate can couple to a puller head on said wire puller.

17. The mount of claim 16 wherein said void is completely enclosed and surrounded by the mount.

18. The mount of claim 16 wherein said horizontal plate is approximately perpendicular to said vertical plate.

19. The mount of claim 16 wherein said vertical plate comprises a hole for coupling onto a puller head.
